(19) United States
(12) Patent Application Publication
(10) Pub. No.: US 2004/0200409 A1
(43) Pub. Date: Oct. 14, 2004

(54) Scrubber with integrated vertical marangoni drying

(75) Inventor: Julia Svirchevski, San Jose, CA (US)

Correspondence Address: PATENT COUNSEL, APPLIED MATERIALS, INC., Legal Affairs Department, P.O.BOX 450A, Santa Clara, CA, 95052, US

(73) Assignee: APPLIED MATERIALS, INC.

(21) Appl. No.: 10/737,732

(22) Filed: Dec. 16, 2003

Related U.S. Application Data
(60) Provisional application No. 60/433,928, filed on Dec. 16, 2002.

(51) Int. Cl. B05D 1/02

(52) U.S. Cl. 118/70; 239/104

(57) ABSTRACT

An apparatus is provided for scrubbing and drying a wafer. The apparatus comprises a chamber, a plurality of rollers adapted to support a wafer in a vertical orientation within the chamber, a pair of brushes adapted to respectively scrub a first and a second side of the wafer, a first spray bar adapted to spray a liquid on the wafer to thereby form a meniscus on the wafer as the wafer is lifted out of the chamber, and a second spray bar adapted to direct a vapor to the meniscus, the vapor being adapted to lower a surface tension of the liquid at the meniscus to thereby perform Marangoni drying of the wafer as the wafer is lifted out of the chamber. Also provided is a method of cleaning and drying a wafer. The method comprises scrubbing a wafer in a vertical orientation, lifting the wafer, spraying a fluid on the wafer as the wafer is lifted, thereby forming a meniscus on the surface of the wafer, and directing a drying vapor to the meniscus as the wafer is lifted, thereby Marangoni drying the wafer.

The present application claims priority from U.S. Provisional Patent Application Serial No. 60/433,928, filed Dec. 16, 2002, which is hereby incorporated by reference herein in its entirety.

### BACKGROUND OF THE INVENTION

It is well known to use a device known as a brush scrubber to clean a semiconductor wafer by scrubbing the wafer with one or more scrubbing brushes. Typically, after cleaning in the scrubber, the wafer is transported to another chamber for rinsing and drying. Stream lining of the cleaning, rinsing and drying process would be desirable.

### SUMMARY

An apparatus is provided for scrubbing and drying a wafer. The apparatus comprises a chamber, a plurality of rollers adapted to support a wafer in a vertical orientation within the chamber, a pair of brushes adapted to respectively scrub a first and a second side of the wafer, a first spray bar adapted to spray a liquid on the wafer to thereby form a meniscus on the wafer as the wafer is lifted out of the chamber, and a second spray bar adapted to direct a vapor to the meniscus, the vapor being adapted to lower a surface tension of the liquid at the meniscus to thereby perform Marangoni drying of the wafer as the wafer is lifted out of the chamber. Also provided is a method of cleaning and drying a wafer. The method comprises scrubbing a wafer in a vertical orientation, lifting the wafer, spraying a fluid on the wafer as the wafer is lifted, thereby forming a meniscus on the surface of the wafer, and directing a drying vapor to the meniscus as the wafer is lifted, thereby Marangoni drying the wafer. Other features and aspects of the present invention will become more fully apparent from the following detailed description, the appended claims and the accompanying drawings.

### BRIEF DESCRIPTION OF THE DRAWINGS

FIG. 1 is a schematic front view of a scrubber provided in accordance with the invention;

FIG. 2 is a top plan view of the scrubber of FIG. 1;

FIG. 3 is a partial cross-section view of a wafer useful in describing an operation for drying the wafer, in accordance with the invention; and

FIG. 4 is a schematic side view of an alternative embodiment in which a wafer enters and exits the enclosure along separate paths.

### DETAILED DESCRIPTION

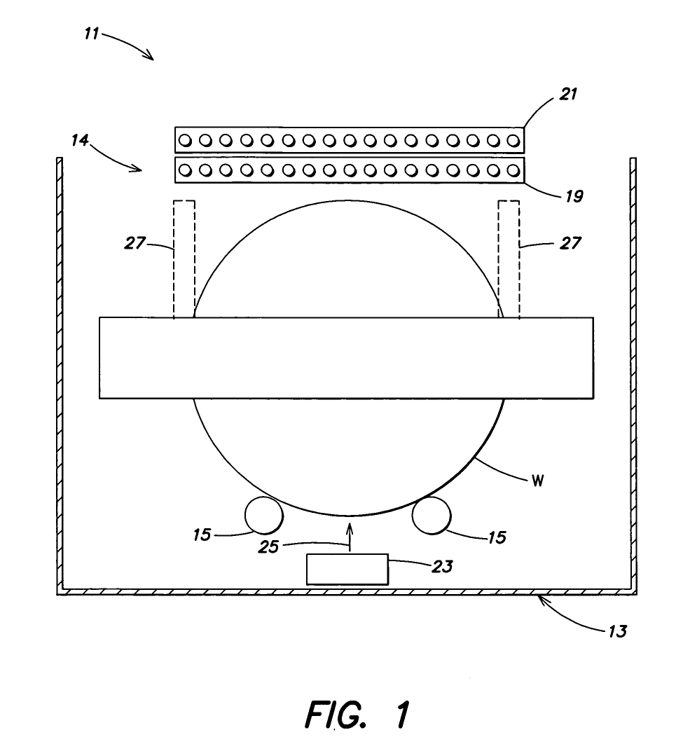

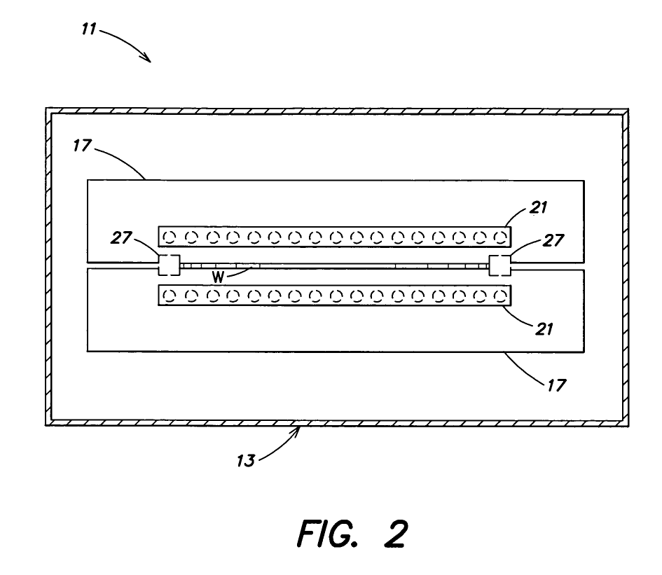

A scrubber 11 that is provided in accordance with the invention is shown in a schematic front view in FIG. 1 and in a top plan view in FIG. 2. The scrubber 11 includes an enclosure 13 having an entry and exit port 14 through which a wafer W may be inserted and removed from the enclosure 13. Within the enclosure 13, is a wafer support mechanism, such as plurality of rollers 15. Scrubber brushes 17 are provided on either side of the wafer W, as is conventional. A first spray bar 19 is positioned above and to a side of the wafer W and is adapted to spray a rinsing fluid such as deionized water (with or without a cleaning agent such as a surfactant) on a major surface of the wafer as the wafer is lifted from the enclosure 13, so as to form a meniscus of fluid on the surface of the wafer W. A second spray bar 21 is positioned above the first spray bar 19, and is adapted to direct a drying vapor (such as an isopropyl alcohol (IPA) vapor) to the major surfaces of the wafer 21.

The lifting of the wafer W from the enclosure 13 may be performed by a device separate from the scrubber 11, such as, for example, the walking beam robot disclosed in U.S. patent application Ser. No. 09/558,815, filed Apr. 26, 2000 (AMAT No. 3156/CMP/RKK), the entire disclosure of which is incorporated herein by reference; or by another type of robot.

Alternatively, a pushing element 23 may be in the enclosure 13, below the wafer W, and may be driven in an upward direction (as indicated by arrow 25) to lift the wafer W out of the enclosure 13 to a point where the wafer may be picked up by a robot (e.g., a walking beam robot, etc.). Vertical guides 27 (shown in phantom) may be mounted in the enclosure 13. Each of the vertical guides 27 is positioned at a respective lateral edge of the wafer W. The vertical guide 27, may be adapted to guide and stabilize the wafer W in its vertical orientation as the wafer W is lifted by the pushing element 23.

Although not shown in the drawing, a liquid source may be coupled to the first spray bar 19. Also not shown is a source of IPA vapor for supplying IPA vapor to the second spray bar 21. IPA may be provided to the second spray bar 21 in accordance with the disclosure of commonly-owned U.S. patent application Ser. No. 10/286,404 (the '404 application) filed Nov. 1, 2002, and incorporated herein in its entirety by this reference.

In operation, the brushes 17 assume an open position and a wafer W is loaded into the inventive scrubber 11 (e.g., by a robot) and placed on the rollers 15. The brushes 17 are moved toward each other as to contact the front and back surfaces of the wafer W. One or more fluids are introduced to the major surface or surfaces of the wafer by means of a fluid distribution arrangement such as a spray bar S. Alternatively, fluid may be supplied via or one or more nozzles or through the brushes 17. While contacting the wafer W, the brushes 17 are rotated about respective longitudinal axes thereof to scrub the wafer W. At the same time, one or more of the rollers 15 is driven to rotate the wafer W as it is being scrubbed.

Upon completion of the scrubbing operation, the brushes 17 are moved apart from each other so as to release the wafer W. Driving of the roller or rollers 15 ceases, so that the wafer W ceases rotation. The wafer W is then lifted (e.g., by the pushing element 23, while being guided and stabilized by the vertical guides 27). As the wafer W begins lifting, liquid is sprayed from the first spray bar 19 so as to form a meniscus on the wafer W, and IPA Vapor is dispensed by the second spray bar 21 to the meniscus so as to induce a Marangoni flow. Although the above description refers to a single spray bar 19 and 21 for supplying fluid and drying vapor respectively, preferably a second pair of spray bars are provided along the backside of the wafer as can be seen in FIG. 2.

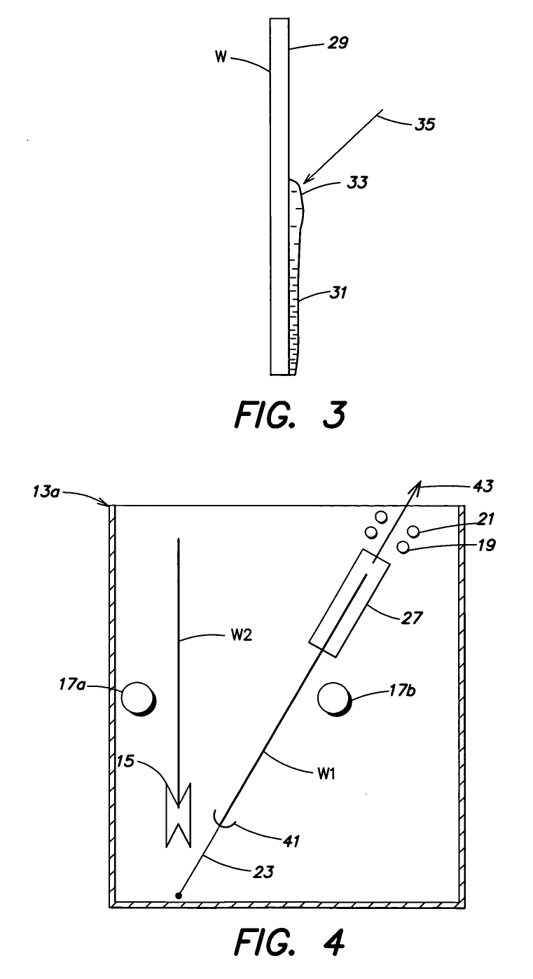

FIG. 3 is a partial cross-sectional view of the wafer W as it is being lifted past the spray bars 19, 21 (which are not shown in FIG. 3). FIG. 3 shows a major surface 29 of the wafer W on which liquid 31 sprayed by the first spray bar 19 forms a meniscus 33. The IPA vapor dispensed by the second spray bar 21 is represented by an arrow 35 in FIG. 3A. The IPA vapor is directed by the second spray bar 21 to the meniscus 33 of the liquid 31 on the major surface 29 of the wafer W. As will be understood by those who are skilled in the art, the IPA vapor 35 impinging on the meniscus 33 causes a reduction in surface tension in the liquid 31 at the meniscus 33, causing the liquid 31 to readily flow off the major surface 29 of the wafer W as the wafer W is raised, thereby providing Marangoni drying of the wafer W.

Types of gas vapor other than IPA vapor may be dispensed by the second spray bar 21 so long as the alternative gas vapor has the effect of reducing the surface tension of the liquid 31 upon impinging on the meniscus 33. An optional output chamber (not shown) may be positioned above the port 14 of the enclosure 13 to receive the wafer W after the wafer W has been lifted out of the enclosure 13. The output chamber, if present, may be of the type which is adapted to rotate the wafer W from the vertical orientation shown in FIG. 1 to a horizontal orientation. Optionally, the output station may then lower with the wafer in the horizontal orientation to a position at which a wafer handling robot may remove the wafer from the output station. An exemplary output chamber of this type is disclosed as an “unload module” and is described in commonly-owned U.S. patent application Ser. No. 09/558,815, filed Apr. 26, 2000 (AMAT No. 3156), the entire disclosure of which is incorporated herein by reference.

FIG. 4 is a schematic side view of an alternative embodiment in which the wafer W enters and exits the enclosure 13 along separate paths. In the exemplary embodiment of FIG. 4, the enclosure 13a has a larger footprint, so that when the brushes 17a-b open, the brush 17b may move farther from the wafer than is the case in the embodiment of FIG. 1. The embodiment of FIG. 4 also includes a moveable cradle 41 which is adapted to contact a lower edge of the vertically oriented wafer W (e.g., after scrubbing is complete) and to move the wafer W from a vertical position to an inclined position.

The pusher 23 of FIG. 4 is adapted so that when a wafer W is in the inclined position, the pusher may elevate, lifting the wafer W from the cradle 41, and pushing the wafer W from the enclosure 13a along an inclined path indicated by arrow 43. Slanted guide rails 27 are positioned along the inclined path so as to guide the wafer W as it is lifted therealong. Similarly, the first and second spray bars 19, 21 are positioned so as to supply rinsing fluid and drying vapor, respectively, on to the wafer W as it is lifted along the inclined path 43, so as to achieve Marangoni drying thereof, as described above.

In operation a first wafer W1 is lowered onto the rollers 15, the brushes 17, 19 close thereagainst, and the first wafer W1 is scrubbed as described above. After scrubbing is complete, the cradle 41 moves into place so as to support the wafer W (e.g., the cradle may contact the wafer W and lift it slightly so that the wafer W clears the uppermost edges of the rollers), and the brushes open. As shown in FIG. 4, when in the open position, the brush 17b moves beyond the guide rails 27. The cradle 41 moves the wafer W to the inclined position and the pusher 23 begins to elevate the wafer W. As the wafer W is lifted it is guided by the guide rails 27 and passes through the rinsing fluid and drying vapor sprays and is Marangoni dried thereby.

Alternatively, rather than rotating the wafer to an inclined position and elevating the wafer along a corresponding inclined path, the cradle may move the wafer linearly from the vertical scrubbing position to a second vertical position from which the wafer may be elevated and dried. An advantage of using separate input and output paths is the ability to receive a second wafer W2 on the rollers while the first wafer W1 is being elevated and dried. Accordingly an increase in the number of wafers processed per hour may be achieved.

In one aspect, whether the wafer is lifted out of the enclosure 13 via a vertical path (e.g., the path in which it was loaded into the enclosure 13) or via a separate path, an output station may be provided to receive the wafer as it is lifted out of the enclosure. The output station may be, for example, of the type described in the '404 application. As disclosed in the '404 application, the output station may have two slots for receiving wafers, so as to further increase the number of wafers that may be processed per hour. Also as disclosed in the patent '404 application, an exhaust manifold and a nitrogen blanket manifold may be provided to contain and exhaust the IPA vapors dispensed by the second spray bar 21. The exhaust and nitrogen blanket manifolds may be provided at a position above the second spray bar 21.

In a further embodiment, an additional spray bar may be included below the fluid spray bar 19. The additional spray bar may spray the same fluid as does the fluid spray bar 19. However, in a preferred embodiment, the additional spray bar sprays surfactant, the spray bar 19 sprays deionized water or surfactant that is more dilute than that sprayed by the additional spray bar (e.g., highly diluted surfactant) and the spray bar 21 sprays a drying vapor.

As used herein the term spray bar may comprise a plurality of nozzles arranged to spray fluid in a line across the wafer's surface, a bar having a plurality of nozzles coupled thereto, or a bar having a plurality of openings through which fluid may drip or spray.

Accordingly, while the present invention has been disclosed in connection with the preferred embodiments thereof, it should be understood that other embodiments may fall within the spirit and scope of the invention, as defined by the following claims.

The invention claimed is:

1. An apparatus comprising;
a chamber;
a plurality of rollers adapted to support a wafer in a vertical orientation within a chamber;
a pair of brushes adapted to scrub a first and a second side of the wafer respectively;
a first spray bar adapted to spray a liquid on the wafer to form a meniscus on the wafer as the wafer is lifted out of the chamber; and
a second spray bar adapted to direct a vapor to the meniscus, the vapor being adapted to lower a surface tension of the liquid at the meniscus to perform Marangoni drying of the wafer as the wafer is lifted out of the chamber.

2. The apparatus of claim 1, further comprising a wafer lift mechanism mounted in the chamber and adapted to lift the wafer at least partially out of the chamber.

3. The apparatus of claim 2, wherein the wafer lift mechanism pushes the wafer upward through a spray output by the first spray bar.

4. The apparatus of claim 2, further comprising a pair of wafer guides for guiding the wafer as the wafer is lifted by the wafer lift mechanism.

5. The apparatus of claim 1, further comprising a cradle for moving the wafer from the vertical orientation to an inclined orientation.

6. The apparatus of claim 5 further comprising a pusher for pushing the wafer upward along an inclined path, wherein the first and second spray bar are positioned to output a spray onto the wafer as the wafer is lifted along the inclined path.

7. The apparatus of claim 6 further comprising a pair of wafer guides for guiding the wafer as the wafer is lifted upward along the inclined path.

8. The apparatus of claim 1 further comprising a mechanism for moving the wafer from a first position where the wafer is scrubbed by the pair of brushes, to a second position where the wafer will be impacted by spray from the first and second spray bars as the wafer is lifted from the chamber.

9. A method of cleaning and drying a wafer comprising:
scrubbing a wafer in a vertical orientation;
lifting the wafer;
spraying a fluid on the wafer as the wafer is lifted, thereby forming a meniscus on the surface of the wafer; and
directing a drying vapor to the meniscus as the wafer is lifted, thereby Marangoni drying the wafer.

10. The method of claim 9, further comprising:
receiving the wafer in a first location for scrubbing; and
moving the wafer to a second location,
wherein lifting the wafer comprises lifting the wafer from the second location.

11. The method of claim 10, further comprising receiving a second wafer in the first location for scrubbing in a vertical orientation, while lifting the first wafer from the second location.

12. The method of claim 10 wherein moving the wafer to the second location comprises rotating the wafer from a vertical orientation to an inclined orientation.

13. The method of claim 10, wherein moving the wafer to the second location comprises linearly translating the wafer to the second location.
